(19) United States
(12) Patent Application Publication
(10) Pub. No.: US 2004/0244186 A1
(43) Pub. Date: Dec. 9, 2004

(54) Tag and method for manufacturing tag

(76) Inventor: Shinichi Umeda, Asaka-shi (JP)

Correspondence Address: JORDAN AND HAMBURG LLP, 122 EAST 42ND STREET, SUITE 4000, NEW YORK, NY, 10168, US

(21) Appl. No.: 10/458,580

(22) Filed: Jun. 9, 2003

(51) Int. Cl. H01Q 17/00

(52) U.S. Cl. 29/601; 29/825; 340/572.7

(57) ABSTRACT

A manufacture method of a tag includes a steps of forming through holes at a predetermined part of an insulated sheet, capable of fixing a conductive ink; and printing an antenna circuit at an upper surface and undersurface of the insulated sheet using the conductive ink so as to close the through hole so that it can reduce the working step since it is unnecessary to perform the formation work of the resist layer for fixing the electric conduction ink; it can form the antenna circuit printed on both surfaces thereof using the conductive ink when the through holes are processed so as to conduct so that it can reduce the working step; and it can reduce the number of the inferior goods remarkably and can be manufactured cheaply.

### BACKGROUND OF THE INVENTION

This invention relates to a tag and method for manufacturing the tag that can be used for theft prevention and distribution channel management of goods and the like.

In the conventional method for manufacturing the tag, after the resist layer for fixing the conductive ink on the upper surface and the undersurface of a sheet of aluminum or film is formed, an antenna circuit is printed on the upper surface of the resist layer by the conductive ink.

After removing the remained resist layer, a through hole is formed in order to conduct both antenna circuits which are printed on the upper surface and undersurface of the sheet, and the conduction step is performed to the through holes.

In the conventional method for manufacturing the tag, the resist layer is formed on the aluminum or film sheet, and the antenna circuit must be printed on the resist layer using the electric conduction ink. Therefore, it is necessary to be performed the formation of the resist layer and the removal work of the remained resist layer; there are many work steps; productivity is bad; and its cost raises.

Moreover, since the through hole is formed by the pattern for opening, the aluminum or film sheet expands and contracts; poor quality is caused in order not to pull the pattern for opening out certainly; and the quality control of the pattern for opening is needed at a high level. Since the through hole has to be carried out the conduction step, it takes time, and its cost rises.

### SUMMARY OF HE INVENTION

Accordingly, it is an object of the invention to provide a tag and method for manufacturing the tag that can reduce the working step since it is unnecessary to perform the formation work of the resist layer for fixing the electric conduction ink. It is another object of the invention to provide a tag and method for manufacturing the tag that can form the antenna circuit printed on both surfaces thereof using the conductive ink when the through holes are processed so as to conduct so that it can reduce the working step. It is further object of the invention to provide a tag and method for manufacturing the tag that can reduce the number of the inferior goods remarkably and can be manufactured cheaply.

Novel features which are believed to be characteristic of the invention, both as to its organization and method of operation, together with further objects and advantages thereof, are described below with reference to the accompanying drawings in which preferred embodiments of the invention are illustrated as an example.

It is to be expressly understood, however, that the drawings are for the purpose of illustration and description only, and are not intended as a definition of the limits of the invention.

### BRIEF DESCRIPTION OF THE DRAWINGS

FIG. 1 is a flow diagram showing a first embodiment of the present invention;

FIG. 2 is an explanation view of a step for forming through holes;

FIG. 3 is an explanation view of a step for forming an antenna circuit;

FIG. 4 is a perspective view;

FIG. 5 is a perspective view from a backside thereof;

FIG. 6 is a sectional view taken along the line 6-6 in FIG. 4;

FIG. 7 is a flow diagram showing a second embodiment of the present invention;

FIG. 8 is a perspective view;

FIG. 9 is a sectional view taken along the line 9-9 in FIG. 8;

FIG. 10 is a flow diagram showing a third embodiment of the present invention;

FIG. 11 is a perspective view;

FIG. 12 is a sectional view taken along the line 12-12 in FIG. 11;

FIG. 13 is a flow diagram showing a fourth embodiment of the present invention;

FIG. 14 is a perspective view;

FIG. 15 is a sectional view taken along the line 15-15 in FIG. 14;

FIG. 16 is a flow diagram showing a fifth embodiment of the present invention;

FIG. 17 is a perspective view;

FIG. 18 is a sectional view taken along the line 18-18 in FIG. 17;

FIG. 19 is a flow diagram showing a sixth embodiment of the present invention;

FIG. 20 is a perspective view; and

FIG. 21 is a sectional view taken along the line 21-21 in FIG. 20;

### DETAILED DESCRIPTION OF THE PREFERRED EMBODIMENTS

Preferred embodiments of the present invention are described in more detail below with reference to the accompanying drawings.

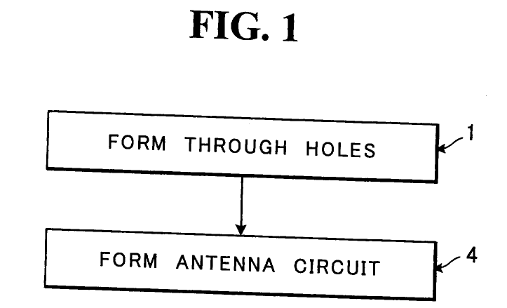

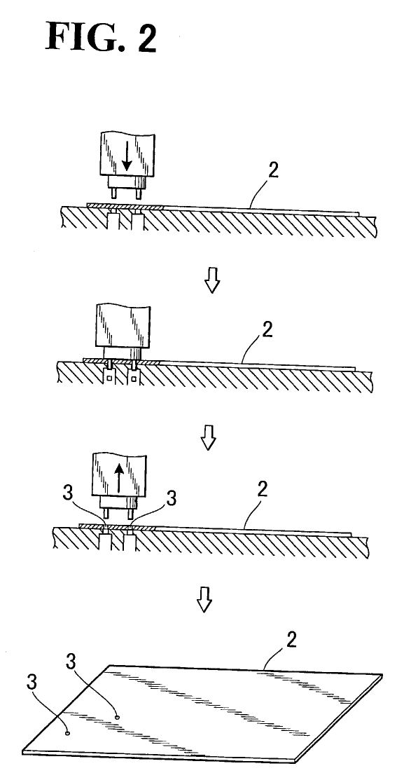

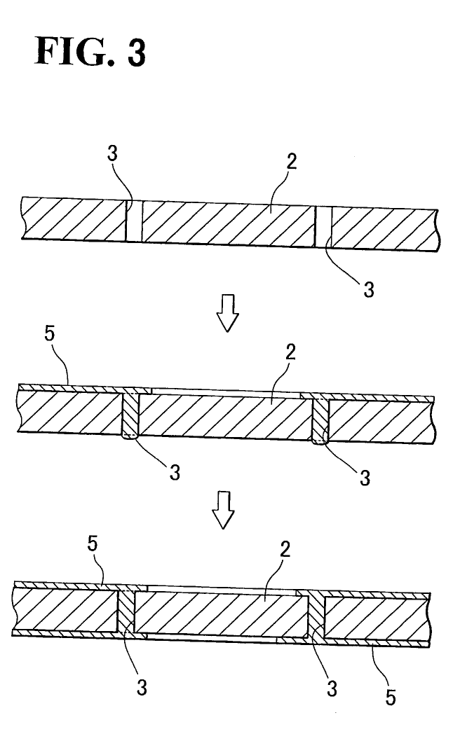

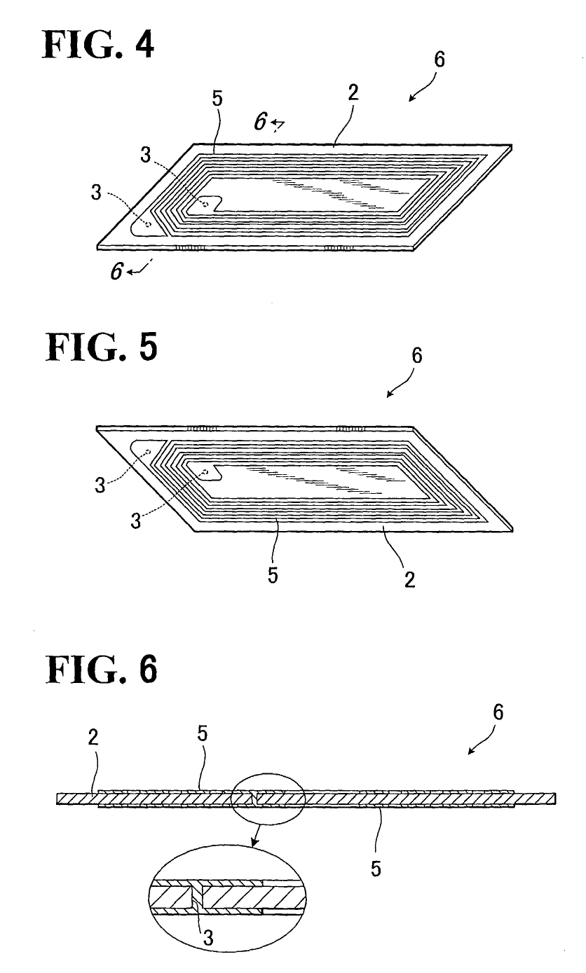

An understanding of the present invention may be best gained by reference to FIGS. 1-6. The numeral 1 shows a step for forming through holes 3 and 3 at a predetermined part, using the coated paper or papers as an insulated sheet 2. When the through holes 3 formed at the formation step 1 are printed in the conductive ink, they are formed using a pattern for opening or a needle. Therefore, the insulated sheet 2 is used paper so that the through holes 3 can be certainly formed by easy work.

The numeral 4 shows a step for forming an antenna circuit 5. The antenna circuit 5 is for communication with the outside entity, power generation and the like. After the formation step 1 is performed, the antenna circuit 5 is printed on the upper surface and the undersurface of the insulated sheet 2 so as to close the through holes 3. In this formation step 4, the printing operation may be carried out either the upper surface or the undersurface of the insulated sheet 2, and the printing operation preferably is carried out the surface which pierced the needle at first when the through hole 3 is formed with a needle.

Since a tag 6 manufactured by the above-mentioned methods uses the insulated sheet 2 of paper, it can be printed the antenna circuit 5 on both sides directly using the conductive ink, and the electric conduction ink is inserted in the through holes 3 when the antenna circuit 5 is printed. Then, both of the antenna circuits 5 are completed at a conduction state.

Therefore, it is not necessary to form the resist layer as before and perform the work step that removes the remained resist layer. Moreover, it is not necessary to perform separately the electric conduction processing of the through holes 3 and 3. The procedure of the manufacturing step can be decreased greatly and it is easy work so that the number of the inferior goods can be reduced remarkably, and the reduction of cost can be performed at the extent which can be used at a throwing-away state.

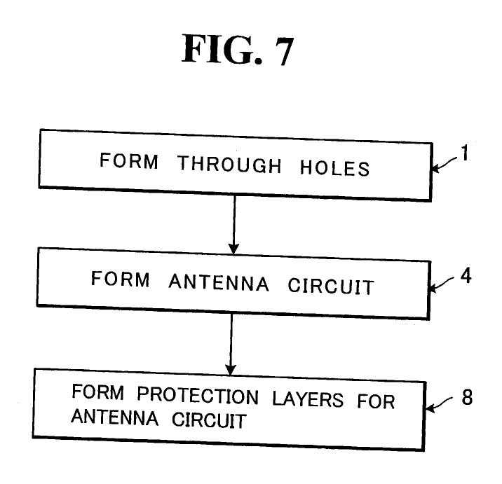

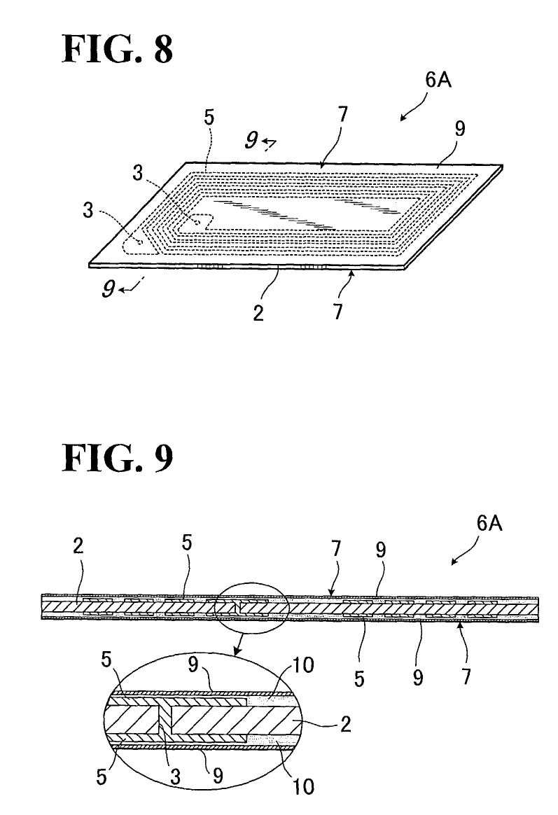

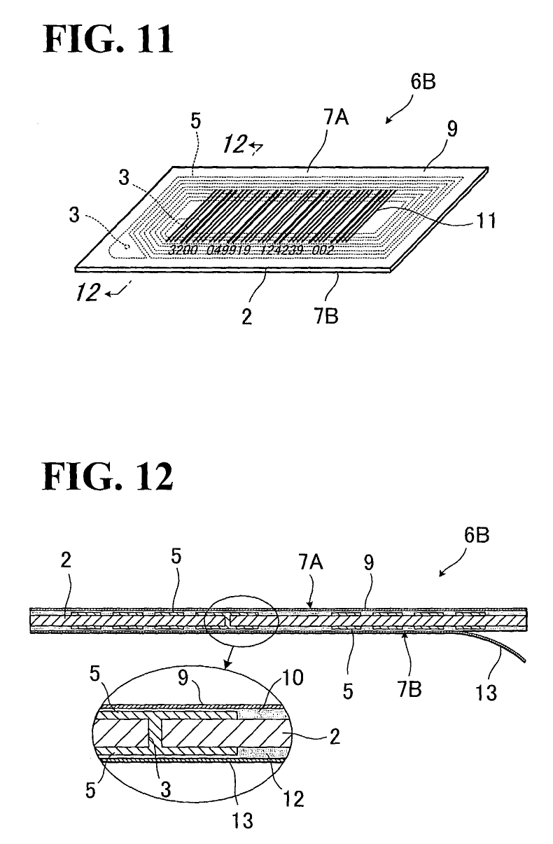

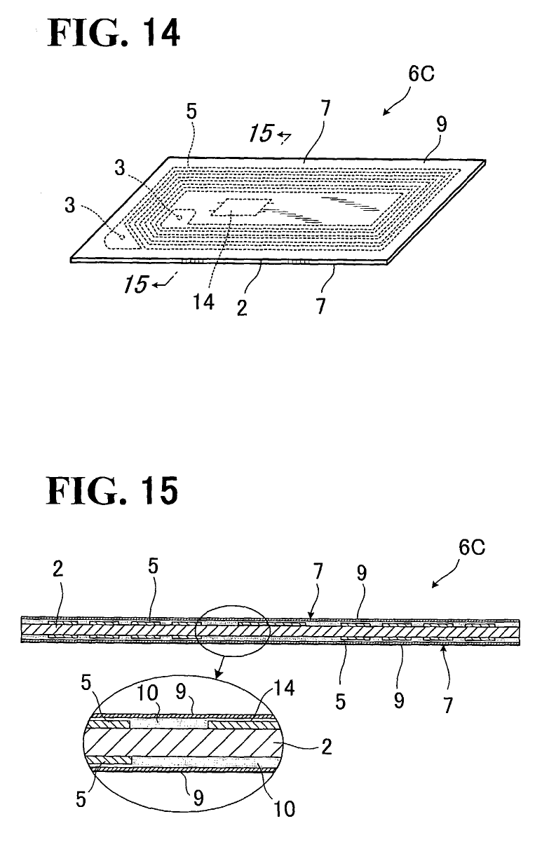

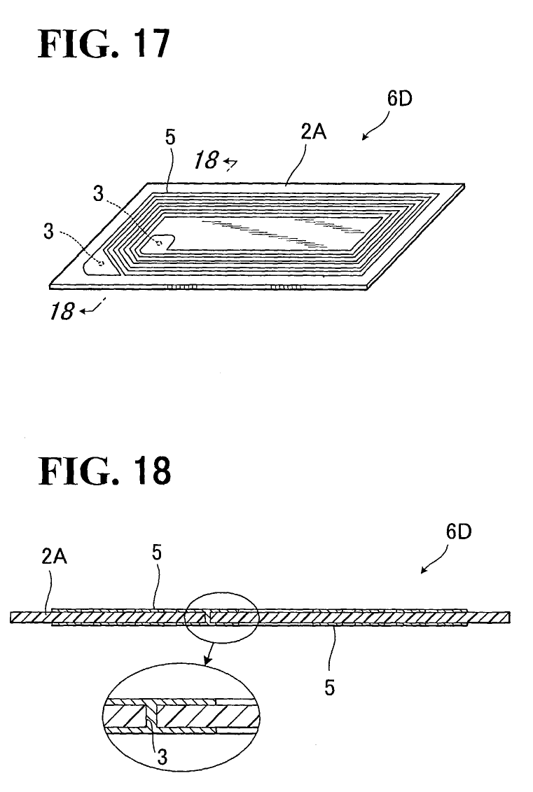

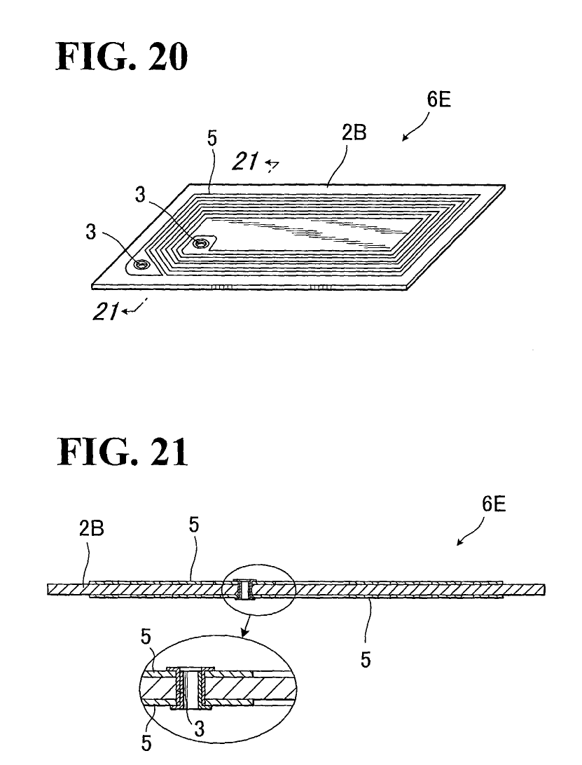

Other embodiments of the present invention will now be described with reference to FIGS. 7-21. In FIGS. 7-21, the same components as in the first embodiment described above with reference to FIGS. 7-21 are designated by the same reference numerals and therefore will not be further explained in great detail.

A second embodiment of the present invention is shown in FIGS. 7-9. It is distinguished from the first embodiment in that a tag 6A is manufactured using a step 8 for forming protection layers 7 and 7 which cover and protect the upper surface of the antenna circuit 5 after the formation step 4 is performed. A method for manufacturing the tag according to the second embodiment has similar advantages to that according to the first embodiment, and the protection layers 7 can protect the antenna circuit 5.

In addition, the protection layers 7 are sheets 9 and 9 made from insulated material that can detect the antenna circuit 5 with the reader device, and the sheets 9 are adhered on the antenna circuit 5 by the adhesives and an adhesion agent 10 made from insulated material.

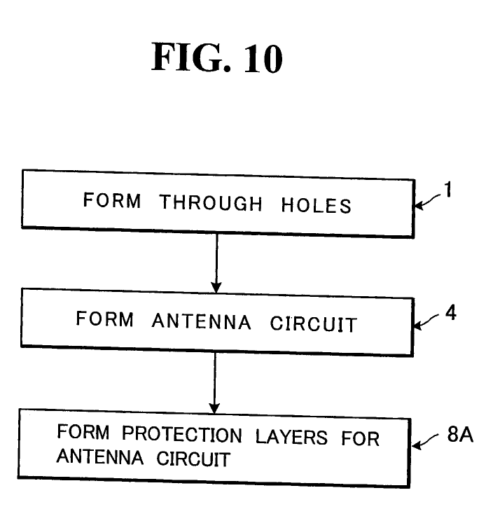

A third embodiment of the present invention is shown in FIGS. 10-12. It is distinguished from the second embodiment in that a protection layer 7A printed a bar code 11 thereon and a protection layer 7B formed by a solvent, an adhesives made from insulated material, or an adhesion agent 12 are used, and a tag 6B is formed using a step 8A for forming the protection layers 7A and 7B. A method for manufacturing the tag according to the third embodiment has similar advantages to that according to the second embodiment.

In addition, the protection layer 7B formed by the adhesives or the adhesion agent is covered in the exfoliation paper 13 until it is used.

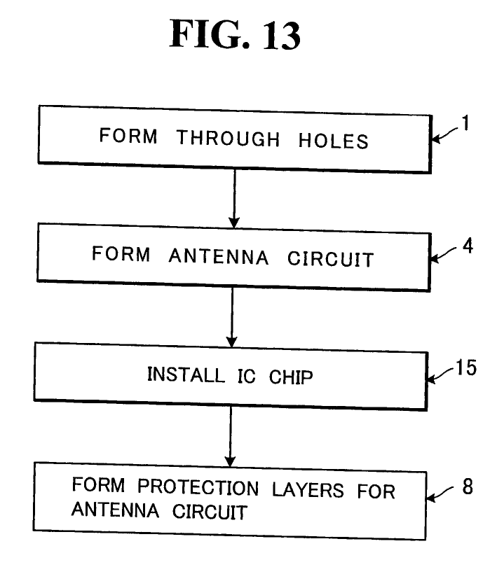

A fourth embodiment of the present invention is shown in FIGS. 13-15. It is distinguished from the second embodiment in that an installation step 15 for installing an IC chip 14 on the insulated sheet 2 either before or after the formation step 4 is performed. An IC tag 6C that is manufactured by the manufacturing method of the tag with the installation step 15 according to the fourth embodiment has similar advantages to that according to the second embodiment, and the IC chip 14 can memorize the information of goods.

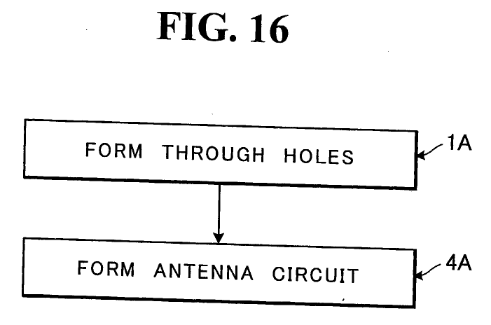

A fifth embodiment of the present invention is shown in FIGS. 16-18. It is distinguished from the first embodiment in that the film made from insulated material which can form the through holes 3 and 3 with a needle is used as an insulated sheet 2A in a formation step 1A, and the antenna circuit 5 is printed on both surfaces of the insulated sheet 2A with the electric conduction ink which is used the adhesives, as a binder, which can be fixed to the insulated sheet 2A in a formation step 4A after the formation step 1A is performed. A tag 6D may be manufactured by the manufacturing method of the tag with the above-mentioned step.

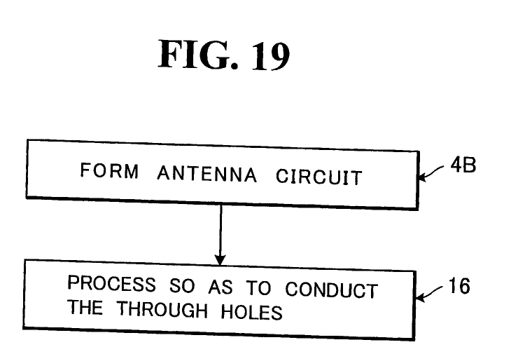

A sixth embodiment of the present invention is shown in FIGS. 19-21. It is distinguished from the first embodiment in that the antenna circuit 5 is printed on both surfaces of an insulated sheet 2B using the coated paper or paper in electric conduction ink in a formation step 4B, and a step 16 which processes so as to conduct the through holes 3 after the through holes 3 are formed is performed. When a tag 6E is manufactured by the manufacture method of the tag using such step, the through holes 3 are formed in the insulated sheet 2B of paper compared with the former tag so that it can form correctly and easily, and the number of inferior goods can be reduced remarkably.

In addition, in each embodiment of the present invention, the formation of the through holes, print of the antenna circuit, formation of the protection layer and the like are performed continuously with the roll volume of the insulated sheet, then the process method, that is, cutting for every piece may be performed.

As set forth above, the advantages of the invention are as follows:

(1) A manufacture method of a tag includes a steps of forming through holes at a predetermined part of an insulated sheet, capable of fixing a conductive ink; and printing an antenna circuit at an upper surface and undersurface of the insulated sheet in the conductive ink so as to close the through hole so that the through hole can be carried out the energization process when the antenna circuit is printed.

Therefore, like before, it is unnecessary to perform the energization process of the through hole as the additional work, and it can reduce its working cost.

(2) As discussed above, since electric conduction ink is pushed into the through hole when the antenna circuit is formed, the energization process of the through hole can be carried out certainly.

Therefore, the number of the inferior goods can be reduced remarkably.

(3) As discussed above, the antenna circuit can be printed at both surfaces of the insulated sheet using the electric conduction ink.

Therefore, it is unnecessary that the resist layer is formed and the remained resist layer is removed, and it can be manufactured more cheaply.

(4) As discussed above, since it performs only the formation of the through hole and the printing of the electric conduction ink, there is no special manufacture equipment, and it can be manufactured with the inexpensive equipment cost.

(5) claim 2 has similar advantages to that according to the effect as above-mentioned (1)-(4), and the protection layer can protect the antenna circuit.

(6) claim 3 has similar advantages to that according to the effect as above-mentioned (1)-(4), and the IC tag, capable of memorizing the goods information in the IC chip, can be manufactured.

(7) claim 4 has similar advantages to that according to the effect as above-mentioned (1)-(4), and the insulated sheet is paper so that it can be used the cheap insulated sheet; it is easy to form the through hole; and it can be carried out correctly.

(8) claims 5, 6, 7 and 8 have similar advantages to that according to the effect as above-mentioned (1)-(4).

What is claimed is:

1. A manufacture method of a tag, comprising a steps of:
forming through holes at a predetermined part of an insulated sheet, capable of fixing a conductive ink; and
printing an antenna circuit at an upper surface and undersurface of the insulated sheet using the conductive ink so as to dose the through hole.

2. A manufacture method of a tag, comprising a steps of:
forming through holes at a predetermined part of an insulated sheet, capable of fixing a conductive ink;
printing an antenna circuit at an upper surface and undersurface of the insulated sheet using the conductive ink so as to dose the through hole; and
forming protection layers which cover and protect the upper surface of the antenna circuit after the printing step is performed.

3. A manufacture method of a tag, comprising a steps of:
forming through holes at a predetermined part of an insulated sheet, capable of fixing a conductive ink;
printing an antenna circuit at an upper surface and undersurface of the insulated sheet using the conductive ink so as to dose the through hole; and
installing an IC chip on the insulated sheet either before or after the printing step is performed.

4. A manufacture method of a tag according to any one of claims 1 to 3, wherein the insulated sheet is paper.

5. A manufacture method of a tag according to any one of claims 2 or 4, wherein the protection layer is one of an insulated sheet, a solvent layer, an adhesive and an adhesion agent layer.

6. A tag comprising:
an insulated sheet of a paper;
through holes formed at a predetermined part of the insulated sheet; and
an antenna circuit printed at an upper surface and undersurface of the insulated sheet using the conductive ink so as to close the through holes.

7. A tag according to claim 6, further comprising protection layers which cover the upper surface of the antenna circuit and protect the antenna circuit.

8. A tag according to claim 6, further comprising an IC chip installed at the insulated sheet so as to connect to the antenna circuit.
